(19) United States
(12) Patent Application Publication
(10) Pub. No.: US 2011/0109702 A1
(43) Pub. Date: May 12, 2011

(54) Inkjet head

(75) Inventors: Jae Hun Kim, Seoul (KR); Jae Woo Joung, Suwon (KR); Yun Sung Kang, Suwon (KR); Ju Hwan Yang, Suwon (KR)

(73) Assignee: SAMSUNG ELECTRO-MECHANICS CO., LTD., Suwon (KR)

(21) Appl. No.: 12/662,950

(22) Filed: May 13, 2010

(30) Foreign Application Priority Data
Nov. 9, 2009 (KR) 10-2009-0107602

(51) Int. Cl. B41J 2/045

(52) U.S. Cl. 347/70

(57) ABSTRACT

There is provided an inkjet head. An inkjet head according to an aspect of the invention may include: a body having a nozzle in an outer surface thereof; a reservoir provided within the body and containing ink being externally injected; an ink chamber receiving the ink from the reservoir through a restrictor and ejecting the ink to an outside through the nozzle; and a reservoir actuator mounted on the body at a position corresponding to the reservoir and transmitting vibrations to the reservoir.

### CROSS-REFERENCE TO RELATED APPLICATIONS

This application claims the priority of Korean Patent Application No. 10-2009-0107602 filed on Nov. 9, 2009, in the Korean Intellectual Property Office, the disclosure of which is incorporated herein by reference.

### BACKGROUND OF THE INVENTION

1. Field of the Invention

The present invention relates to inkjet heads, and more particularly, to a method of manufacturing an inkjet head that allows ink to be smoothly supplied to the inside of a chamber.

2. Description of the Related Art

In general, an inkjet head converts an electric signal into a physical force so that ink droplets are ejected through small nozzles.

In recent years, piezoelectric inkjet heads have also been used in industrial inkjet printers. For example, a circuit pattern is directly formed by spraying ink prepared by melting metals such as gold or silver onto a printed circuit board (PCB). A piezoelectric inkjet head is also used for industrial graphics, and is used in the manufacturing of a liquid crystal display (LCD) and an organic light emitting diode (OLED).

In general, an inkjet head of an inkjet printer has an inlet and an outlet through which ink is introduced into and ejected from a cartridge, a reservoir storing the ink being introduced, and chambers transmitting a driving force of an actuator in order to move the ink in the reservoir to the nozzles .

Here, when the rate at which the ink is ejected through the nozzles inside the ink chambers is the same as the rate at which the ink is supplied into the ink chambers, the inkjet head can produce accurate printing. If the ink supply rate cannot catch up with the rate at which the ink is ejected, however, the ink is not ejected in midstream, thereby adversely affecting printing quality.

In particular, when the ink stored in the chambers of the inkjet head has large droplets, this ink supply rate acts as an important factor determining printing quality. Therefore, there is a need for techniques to solve these problems.

### SUMMARY OF THE INVENTION

An aspect of the present invention provides an inkjet head that efficiently supplies ink into a chamber to thereby improve printing quality.

According to an aspect of the present invention, there is provided an inkjet head including: a body having a nozzle in an outer surface thereof; a reservoir provided within the body and containing ink being externally injected; an ink chamber receiving the ink from the reservoir through a restrictor and ejecting the ink to an outside through the nozzle; and a reservoir actuator mounted on the body at a position corresponding to the reservoir and transmitting vibrations to the reservoir.

An upper surface of the reservoir may be lower than that of the ink chamber.

An upper surface of the reservoir may be on the same plane as that of the ink chamber.

The reservoir actuator may be provided on one surface of the body that is the same as the outer surface thereof in which the nozzle is provided.

The body may include a vibration plate interposed between a surface of the body and the reservoir actuator.

The inkjet head may further include a chamber actuator mounted on the body at a position corresponding to the ink chamber.

The reservoir actuator and the chamber actuator maybe provided on the same surface of the body.

The reservoir actuator may be provided on a surface opposite to one surface of the body onto which the chamber actuator is mounted.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an inkjet head according to an exemplary embodiment of the present invention;

FIG. 2 is a cross-sectional view illustrating the inkjet head of FIG. 1;

FIGS. 3 and 4 are cross-sectional views illustrating the operation of an inkjet head according to an exemplary embodiment of the present invention; and

FIG. 5 is a schematic sectional view illustrating an inkjet head according to another exemplary embodiment of the present invention.

### DETAILED DESCRIPTION OF THE PREFERRED EMBODIMENT

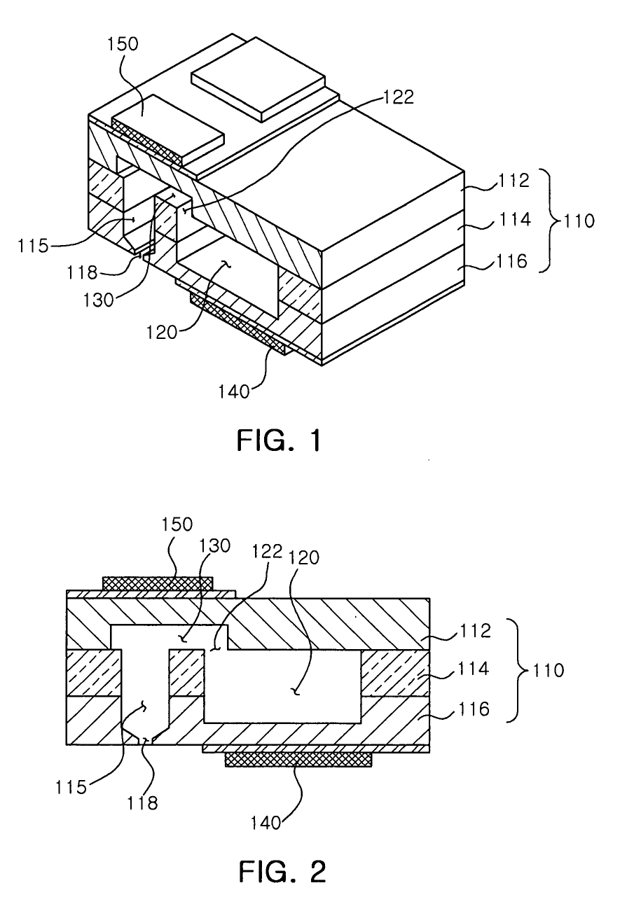

An inkjet head according to an exemplary embodiment of the invention will be described in more detail with reference to FIGS. 1 through 5. Exemplary embodiments of the present invention will now be described in detail with reference to the accompanying drawings.

The invention may, however, be embodied in many different forms and should not be construed as being limited to the embodiments set forth herein. While those skilled in the art could readily devise many other varied embodiments that incorporate the teachings of the present invention through the addition, modification or deletion of elements, such embodiments may fall within the scope of the present invention.

FIG. 1 is a schematic perspective view illustrating an inkjet head according to an exemplary embodiment of the invention. FIG. 2 is a cross-sectional view illustrating the inkjet head of FIG. 1.

Referring to FIGS. 1 and 2, an inkjet head may include a body 110, a reservoir 120, an ink chamber 130, and a reservoir actuator 140.

A nozzle 118 may be formed in one surface of the body 110, in which the reservoir 120 and the ink chamber 130 may be disposed.

Here, the body 110 may be formed by attaching a flow path plate 112, an intermediate plate 114, and a lower plate 116 to each other. However, the body 110 is not limited to this configuration and may be formed by using two plates.

Ink is externally transmitted and stored in the reservoir 120. A recess having an internal space may be formed in the intermediate plate 114 and the lower plate 116.

A path through which the external ink is transmitted to the reservoir 120 may be one inlet (not shown) that is formed in one surface of the body 110. However, the body 110 does not contain a single inlet. An inlet may correspond to the ink chamber 130.

Here, the reservoir 120 may be connected to the ink chamber 130 through a restrictor 122. The ink, stored in the reservoir 120, is transmitted to the ink chamber 130 through the restrictor 122.

Here, since the reservoir 120 may be located below the level of the ink chamber 130, the restrictor 122 is formed vertically relative to the inner surface of the body 110.

The ink chamber 130 is provided at a position where the chamber actuator 150 is mounted. Here, a portion of the flow path plate 112 that forms a ceiling of the ink chamber 130 serves as a vibration plate.

Therefore, when a driving signal is applied to the chamber actuator 150 in order to eject the ink, the vibration plate thereunder is deformed, together with the chamber actuator 150, to thereby deform the volume of the ink chamber 130.

Here, the reduction in the volume of the ink chamber 130 increases the pressure inside the ink chamber 130, so that ink inside the ink chamber 130 is ejected to the outside through a damper 115 and the nozzle 118.

Electrodes may be electrically formed on upper and lower surfaces of the chamber actuator 150, and may be formed of Lead Zirconate Titanate (PZT) ceramic materials, which are one of piezoelectric materials.

Here, the damper 115 may have a large length extending in a longitudinal direction in the intermediate plate 114 and serve as a path that connects the ink chamber 130 and the nozzle 118.

The damper 115 may have a multi-stage shape, which allows controlling the amount of ink being supplied from the ink chamber 130 and the amount of ink moving toward the nozzle 118.

Here, the damper 115 is optional and may be removed. In this case, the inkjet head only includes the flow path plate 112 and the lower plate 116.

The reservoir actuator 140 is mounted on the outside of the body 110. A mounting surface on which the reservoir actuator 140 is mounted on the body 110 is adjacent to the reservoir 120. Here, in this embodiment, since the reservoir 120 is located below the level of the ink chamber 130, the reservoir actuator 140 may be bonded to a surface opposite to the surface to which the chamber actuator 150 is bonded.

Here, like the chamber actuator 150, the reservoir actuator 140 may be formed of a piezoelectric material, and electrodes may be formed on upper and lower surfaces of the reservoir actuator 140 in order to provide electrical connections.

A surface, which comes in contact with the reservoir actuator 140, serves as one vibration plate, and the surface is deformed when the reservoir actuator 140 vibrates, so that ink inside the reservoir 120 flows.

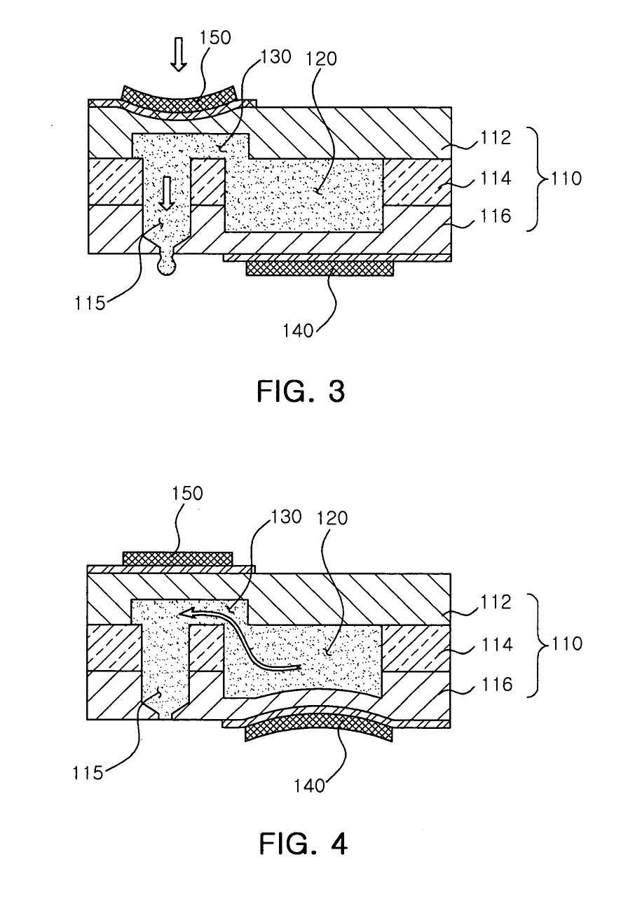

FIGS. 3 and 4 are cross-sectional views illustrating the operation of an inkjet head according to an exemplary embodiment of the invention.

Referring to FIG. 3, the chamber actuator 150 is mounted on one surface of the body 110, which is adjacent to the ink chamber 130.

Then, as shown in FIG. 3, when the chamber actuator 150 vibrates downwards (in the direction of the arrow of FIG. 3), the ink inside the ink chamber 130 is ejected to the outside through the damper 115 and the nozzle 118.

Here, after the ink is ejected, the ink, stored in the reservoir 120, is naturally moved toward to the ink chamber 130 through the restrictor 122 due to pressure exerted by fluid.

Here, when ink has large droplets, the above-described movement of the ink is hindered, and thus the ink may not be ejected, thereby adversely affecting printing quality.

However, in this embodiment, since the reservoir actuator 140 is mounted on the one surface of the body 110, which is adjacent to the reservoir 120, the ink, stored in the reservoir 120, is smoothly moved to the ink chamber 130.

Specifically, as shown in FIG. 4, as the reservoir actuator 140 vibrates, the vibration plate becomes curved inwards, and the reservoir 120 is deformed, so that the ink inside the reservoir 120 is forcibly moved toward the ink chamber 130.

Therefore, in the inkjet head according to this embodiment, as the ink, stored in the reservoir 120, is forcibly moved to the ink head by the reservoir actuator 140, the ink, stored in the reservoir 120, can be accurately supplied in a quantity equal to the amount of ink being ejected, thereby preventing the non-ejection of ink. As a result, printing quality can be improved.

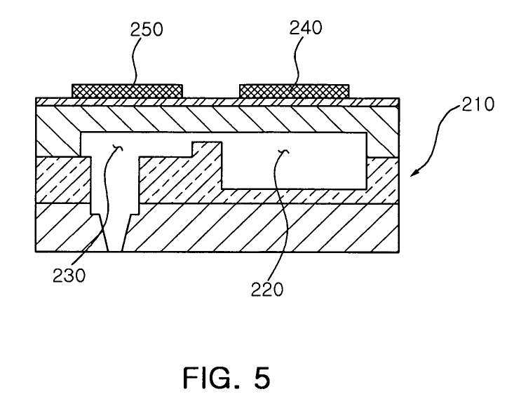

FIG. 5 is a schematic sectional view illustrating an inkjet head according to another exemplary embodiment of the invention.

Referring to FIG. 5, an inkjet head according to this embodiment may include a body 210, a reservoir 220, an ink chamber 230, a reservoir actuator 240 and a chamber actuator 250.

Here, since the configurations of these components are the same as those of the components according to the above-described embodiment, a detailed description thereof may be omitted.

Here, the reservoir 220 is disposed to abut the ink chamber 230 such that the restrictor 222 may have a large length extending in a longitudinal direction of the inkjet head.

The reservoir actuator 240 is mounted on one surface of the body 210 that is adjacent to the reservoir 220. Here, the reservoir actuator 240 and the chamber actuator 250 maybe mounted on the same surface.

That is, the reservoir actuator 240 and the chamber actuator 250 are formed on the same surface, thereby facilitating manufacturing operations.

Furthermore, in the inkjet head according to this embodiment, as the ink, stored in the reservoir 220, is forcibly moved to the ink head by the reservoir actuator 240, it is possible to accurately supply the ink inside the reservoir 220, thereby improving printing quality.

As set forth above, according to exemplary embodiments of the invention, an inkjet head includes a reservoir actuator that is mounted on a body at a position corresponding to a reservoir to thereby transmit vibrations to the reservoir, so that the amounts of ink inside the reservoir, corresponding to the amounts of ink having been ejected, can be supplied to the ink head.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head comprising:
a body having a nozzle in an outer surface thereof;
a reservoir provided within the body and containing ink being externally injected;
an ink chamber receiving the ink from the reservoir through a restrictor and ejecting the ink to an outside through the nozzle; and
a reservoir actuator mounted on the body at a position corresponding to the reservoir and transmitting vibrations to the reservoir.

2. The inkjet head of claim 1, wherein an upper surface of the reservoir is lower than that of the ink chamber.

3. The inkjet head of claim 1, wherein an upper surface of the reservoir is on the same plane as that of the ink chamber.

4. The inkjet head of claim 1, wherein the reservoir actuator is provided on one surface of the body that is the same as the outer surface thereof in which the nozzle is provided.

5. The inkjet head of claim 1, wherein the body comprises a vibration plate interposed between a surface of the body and the reservoir actuator.

6. The inkjet head of claim 1, further comprising a chamber actuator mounted on the body at a position corresponding to the ink chamber.

7. The inkjet head of claim 6, wherein the reservoir actuator and the chamber actuator are provided on the same surface of the body.

8. The inkjet head of claim 6, wherein the reservoir actuator is provided on a surface opposite to one surface of the body onto which the chamber actuator is mounted.
